(19) United States
(12) Patent Application Publication
(10) Pub. No.: US 2022/0187895 A1
(43) Pub. Date: Jun. 16, 2022

(54) INFORMATION PROCESSING DEVICE

(71) Applicant: NTT DOCOMO, INC., Chiyoda-ku (JP)

(72) Inventors: Takashi HAMATANI, Chiyoda-ku (JP); Keiichi OCHIAI, Chiyoda-ku (JP); Naoki YAMAMOTO, Chiyoda-ku (JP); Yusuke FUKAZAWA, Chiyoda-ku (JP)

(73) Assignee: NTT DOCOMO, INC., Chiyoda-ku (JP)

(21) Appl. No.: 17/441,371

(22) PCT Filed: Jan. 30, 2020
(86) PCT No.: PCT/JP2020/003495

§ 371 Date: Sep. 21, 2021

(30) Foreign Application Priority Data
Mar. 25, 2019 (JP) 2019-056349

(51) Int. Cl. G06F 1/3215; G01P 15/00

(52) U.S. Cl. CPC G06F 1/3215; H04W 52/0261; G01P 15/00

(57) ABSTRACT

An object is to provide an information processing device capable of reducing power consumption for acquiring sensor values and preventing a loss of an important sensor value. A power saving model server (100) is an information processing device for controlling a plurality of sensors (acceleration sensor 201, etc.) that respectively detect a plurality of terminal states. The power saving model server (100) includes a sensor control unit (104) that stops an operation related to one or a plurality of sensors among the plurality of sensors on the basis of the plurality of terminal states.

### TECHNICAL FIELD

The present invention relates to an information processing device that controls a sensor for detecting a motion, such as acceleration, of a terminal.

### BACKGROUND ART

Patent Literature 1 describes mounting an acceleration sensor on a mobile phone and detecting a motion of the mobile phone.

### CITATION LIST

### Patent Literature

PTL1: Japanese Unexamined Patent Publication No. 2011-148415

### SUMMARY OF INVENTION

### Technical Problem

Mobile terminals such as smartphones are used for a variety of applications today. Studies of sensing a user's behavior and conditions with use of a communication terminal have been conducted. A communication terminal is able to acquire a variety of information such as motion, position, and usage. Many studies have reported that the accuracy of estimating the behavior and conditions is enhanced by combining a plurality of information. One possible technique is to constantly collect a large amount of information with a mobile phone having a plurality of types of sensors, which, however, causes the power consumption of the sensors to increase.

One approach is to turn on and off each sensor of a mobile terminal at regular intervals to thereby reduce the power consumption.

However, since this approach interrupts data acquisition regardless of a user's usage status, it causes important data to be partially lost as a result of giving priority to power saving in spite of the fact that data when a user is holding and operating a communication terminal is especially important in estimating the user's condition.

To solve the above problem, an object of the present invention is to provide an information processing device capable of reducing power consumption for acquiring sensor values and preventing a loss of an important sensor value.

### Solution to Problem

To solve the above problem, an information processing device according to the present invention is an information processing device for controlling a plurality of detection units that respectively detect a plurality of terminal states, including a sensor control unit configured to stop an operation related to one or a plurality of detection units among the plurality of detection units on the basis of the plurality of terminal states.

The present invention reduces the power consumed by the operation of a detection unit. Further, since the operation of a sensor is stopped according to a terminal state, the present invention prevents a loss of a sensor value on the basis of an important operation of a detection unit.

### Advantageous Effects of Invention

The present invention achieves reduction of power consumption for acquiring sensor values and prevention of a loss of an important sensor value.

### BRIEF DESCRIPTION OF DRAWINGS

FIG. 1 is a block diagram showing functional configurations of a power saving model server 100 and a communication terminal 200 according to an embodiment.

FIG. 2 is a schematic view showing a power saving model generation process.

FIG. 3 is a flowchart showing a process of the power saving model server 100.

FIG. 4 is flowchart showing a feature value estimation process using a power saving model.

FIG. 5 is a block diagram showing a functional configuration of a communication terminal 200a according to an alternative example.

FIG. 6 is a flowchart showing sensor control and interpolation control using a power saving model of the communication terminal 200a.

FIG. 7 is a view showing an example of hardware configurations of the power saving model server 100 and the communication terminal 200 according to one embodiment of the present disclosure.

### DESCRIPTION OF EMBODIMENTS

Embodiments of the present invention are described hereinafter with reference to the attached drawings. Note that, where possible, the same elements are denoted by the same reference symbols and redundant description thereof is omitted.

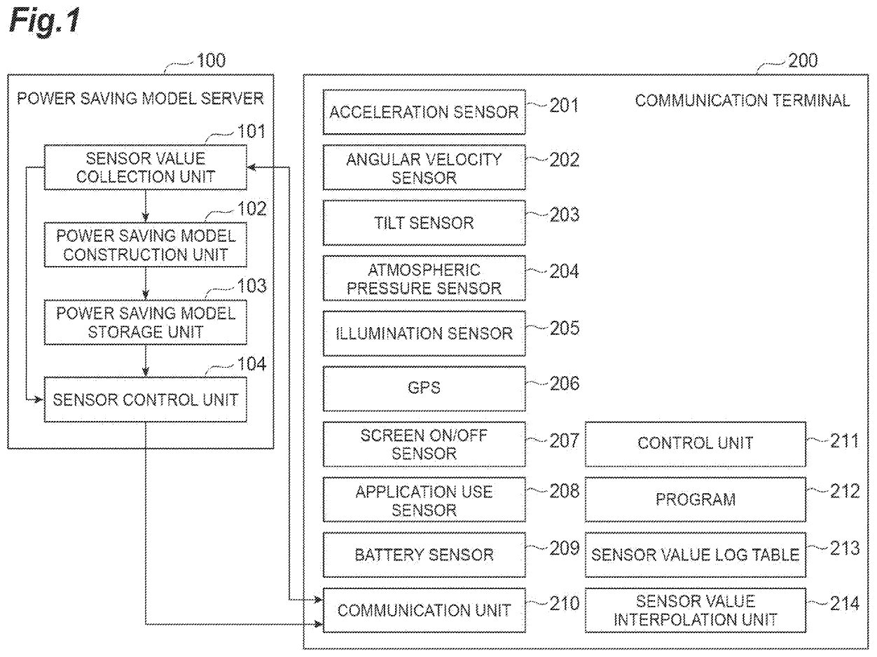

FIG. 1 is a block diagram showing functional configurations of a power saving model server 100 and a communication terminal 200 according to an embodiment. As shown in FIG. 1, the power saving model server 100 includes a sensor value collection unit 101, a power saving model construction unit 102, a power saving model storage unit 103, and a sensor control unit 104. The communication terminal 200 includes an acceleration sensor 201, an angular velocity sensor 202, a tilt sensor 203, an atmospheric pressure sensor 204, an illumination sensor 205, a GPS 206, a screen on/off sensor 207, an application use sensor 208, a battery sensor 209, a communication unit 210, a control unit 211, a program 212, a sensor value log table 213, and a sensor value interpolation unit 214 (detection result interpolation unit).

The sensor value collection unit 101 is a part that collects sensor values of sensors (the acceleration sensor 201 etc.), which constitute a detection unit of the communication terminal 200. The sensor values include the number of access points, which indicates the communication status of the communication unit 210, location information measured by the GPS 206, and the like.

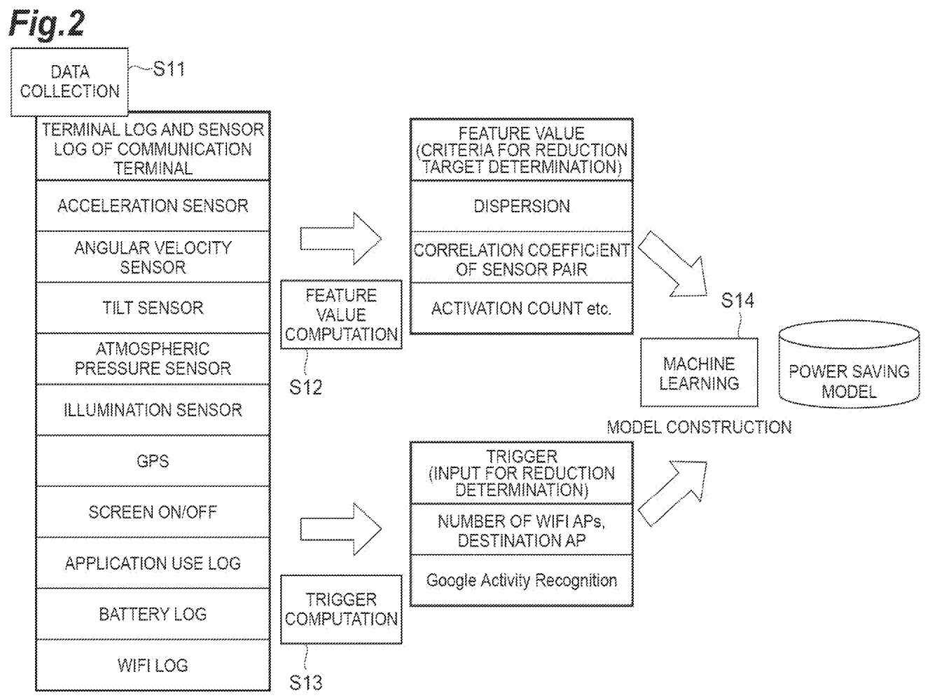

The power saving model construction unit 102 is a part that constructs a power saving model on the basis of the sensor values collected by the sensor value collection unit 101, and stores the power saving model into the power saving model storage unit 103. A specific construction process of described hereinafter with reference to FIG. 2. FIG. 2 is a schematic view showing a power saving model generation process.

As shown in Step S11, data collection of the sensor values detected by the sensors is performed in the communication terminal 200 (S11). Then, the power saving model construction unit 102 calculates the feature value of the sensor values of the acceleration sensor 201, the angular velocity sensor 202, the tilt sensor 203, the atmospheric pressure sensor 204, the illumination sensor 205, the screen on/off sensor 207, the application use sensor 208, and the battery sensor 209 (S12). The feature value may be a dispersion of each sensor value per unit time, a correlation coefficient of a pair of sensors, a sensor activation count, or the like. Although use of a Person's correlation coefficient as the correlation coefficient is assumed in the following description, it is not limited thereto as long as it can determine the similarity between sensor values of a plurality of sensors. Besides the correlation coefficient, a dynamic time warping distance, an Euclidean distance or the like may be used as the similarity between a pair of sensors.

Further, the sensor value collection unit 101 collects a WiFi log, which is a communication status log of the communication unit of the communication terminal 200, and user's behavior information (behavior log). The power saving model construction unit 102 computes trigger information on the basis of those information (S13). As the trigger information, the number of WiFi APs (the number of access points) and a destination AP (SSID, which is the name of an access point) are acquired from the WiFi log.

Note that the user's behavior information is behavior information estimated in the communication terminal 200 on the basis of a sensor value of the acceleration sensor 201 or the like in the communication terminal 200. This behavior information is information acquired in the communication terminal 200 by the Google Activity Recognition feature, for example. The behavior information is information indicating riding on a vehicle, stopping, walking and the like. This user's behavior information is treated as trigger information in this embodiment.

The feature value is used as criteria for determining a target of reduction in the sensor operation, and the trigger information is used as a start trigger for determination on reduction.

Then, the power saving model construction unit 102 constructs a power saving model by training the power saving model whose response variable is the feature value and explanatory variable is the trigger information (S14).

The sensor control unit 104 is a part that estimates the feature value (dispersion of each sensor, a correlation coefficient, etc.) of the sensor value of a user by using the trigger information and the power saving model collected from the communication terminal 200, and controls the communication terminal 200 on the basis of the estimated feature value. Specifically, the sensor control unit 104 determines which sensor has no variations and whether there is a correlation between sensors on the basis of the estimated feature value. The sensor control unit 104 then stops the operation of the sensor with no variations. Further, when there is a correlation between sensors, the sensor control unit 104 stops the operation of one of the sensors. Note that, the sensors may be grouped into pairs, and it may be predetermined which of each pair is to be stopped. Alternatively, the sensors may be grouped into combinations of three or more sensors.

In this embodiment, stopping the operation of a sensor includes stopping the operation of an actual sensor, and also includes not acquiring a sensor value detected by a sensor. For example, an OS (Operating System) of the communication terminal 200 has a function of acquiring sensor values all the time. The sensor values acquired by this function are stored in a memory of the communication terminal 200. Another application acquires a sensor value stored in this memory and thereby implements a specified service. In this embodiment, stopping the operation of a sensor includes stopping the acquisition of a sensor value stored in this memory. This has the effect of reducing power consumption.

When each sensor of the communication terminal 200 is stopping, the sensor control unit 104 puts the sensor that has been out of operation into operation on the basis of the feature value of each sensor value estimated from the trigger information. For example, when a variation is expected to occur in the sensor out of operation on the basis of the feature value, the sensor control unit 104 puts the sensor that has been out of operation into operation. Further, when it is expected that a correlation no longer exists between a pair of sensors, the sensor control unit 104 puts the sensor that has been out of operation into operation.

The communication terminal 200 is described hereinbelow. In the communication terminal, the acceleration sensor 201 is a sensor that detects the acceleration applied to the communication terminal 200.

The angular velocity sensor 202 is a sensor that detects the angular velocity applied to the communication terminal 200.

The tilt sensor 203 is a sensor that detects the tilt of the communication terminal 200 to measure its posture.

The atmospheric pressure sensor 204 is a sensor that detects the atmospheric pressure around the communication terminal 200.

The illumination sensor 205 is a sensor that detects the illumination and brightness around the communication terminal 200.

The GPS 206 is a part that measures the position of the communication terminal 200.

The screen on/off sensor 207 is a sensor that detects whether a display unit (not shown) of the communication terminal 200 is on or off. For example, the screen on/off sensor 207 detects whether the display unit is in sleep mode and displaying nothing, or displaying information such as a home screen.

The application use sensor 208 is a sensor that detects which application is used by a user.

The battery sensor 209 is a sensor that checks the battery power level.

The communication unit 210 is a part that establish a communication connection to the power saving model server 100 or a network. This communication unit 210 also has a function of performing WiFi communication, and it specifically has a function of establishing a communication connection to a WiFi access point and detecting its communication log.

The control unit 211 is a part that controls the communication terminal 200. Further, the control unit 211 has a function of estimating a user's behavior. For example, the Google Activity Recognition provided by Google (registered trademark) is a function of estimating a user's behavior on the basis of sensor values of the above-described sensors, and the control unit performs the Google Activity Recognition and acquires user's behavior information.

The program 212 is a program for the communication terminal 200 to execute a communication function and other functions.

The sensor value log table 213 stores sensor values of the above-described sensors, a communication log of the communication unit 210, and user's behavior information in association with time information.

When each of the above-described sensors is stopping, the sensor value interpolation unit 214 performs interpolation of a sensor value on the basis of processing determined according to a reason for the stop. The interpolated sensor value is written into a sensor value log table.

When the sensor value interpolation unit 214 has received, from the power saving model server 100, a control command to stop a sensor with small variations in the sensor value (the level of dispersion is a predetermined value or less), the sensor value interpolation unit 214 performs interpolation of a sensor value by performing linear interpolation for this sensor on the basis of a sensor value at the time of stop and a sensor value at the time of restart.

Further, when the sensor value interpolation unit 214 has received, from the power saving model server 100, a control command to stop one of a pair of sensors with a large correlation of sensor values (for example, a Pearson's correlation coefficient is a predetermined value or more), the sensor value interpolation unit 214 performs interpolation with use of a sensor value of the sensor that has been stopped out of the pair of sensors by copying a sensor value of the other sensor that is not stopped, for example. Note that this sensor value may be copied, or a value obtained by multiplying the sensor value by a correction coefficient on the basis of the characteristics of this sensor may be copied. When a correlation of sensor values becomes smaller (for example, a correlation coefficient falls below a predetermined value), and the stop command is cancelled, the interpolation is not performed.

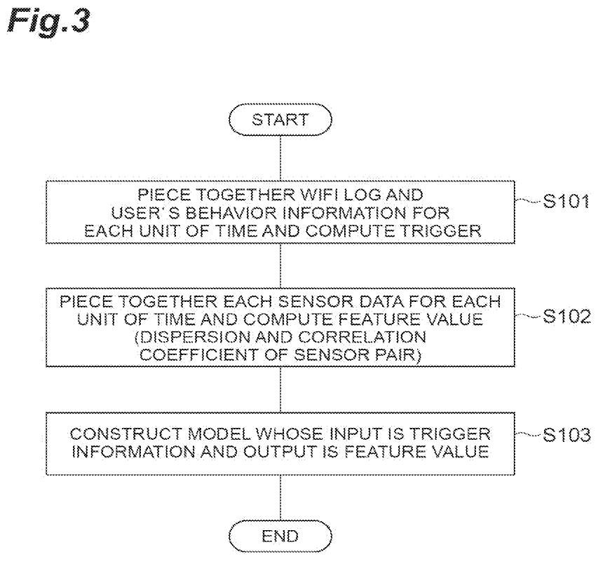

The operation of the power saving model server 100 according to this embodiment is described hereinafter. FIG. 3 is a flowchart showing a process of the power saving model server 100. The sensor value collection unit 101 collects sensor values of the communication terminal 200, a WiFi log, and user's behavior information in advance, and stores them into a sensor value management table (not shown).

The power saving model construction unit 102 pieces together the WiFi log and the user's behavior information for each unit of time from the sensor value management table and computes trigger information (S101). For example, the power saving model construction unit 102 refers, every five minutes, to the WiFi destination and the user's behavior information in the last 15 minutes, and compiles information about the same destination, the same number of connections, the user's behavior such as stopping or riding on a vehicle and the like.

Further, the power saving model construction unit 102 pieces together the sensor values of a predetermined sensor for each unit of time from the sensor value management table and computes the feature value (S102). For example, the power saving model construction unit 102 refers, every five minutes, to the sensor values of each sensor in the last 15 minutes, and computes the dispersion of each sensor and the correlation coefficient of the sensor values for each predetermined pair of sensors.

Then, the power saving model construction unit 102 constructs a power saving model whose input is trigger information and output is a feature value. This power saving model is a learning model constructed by machine learning, and a known technique is used for the construction.

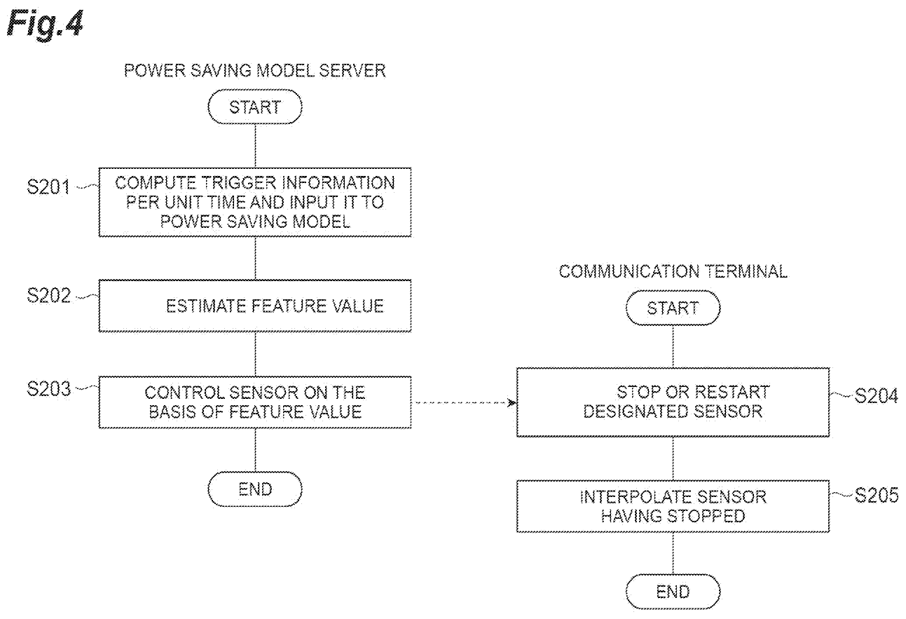

Next, a process of estimating a feature value from the trigger information by using the power saving model in the power saving model server 100 is described hereinafter. FIG. 4 is a flowchart showing the feature value estimation process using the power saving model.

The sensor control unit 104 computes the trigger information on the basis of the WiFi log and the user's behavior information per unit time of the communication terminal 200, which are collected by the sensor value collection unit 101. For example, the sensor control unit 104 computes the trigger information by referring, every five minutes, to the WiFi log and the user's behavior information in the last 15 minutes. Then, the sensor control unit 104 inputs the trigger information to the power saving model (S201).

The sensor control unit 104 estimates a feature value from the power saving model (S202). Then, the sensor control unit 104 controls the operation of the sensors of the communication terminal 200 on the basis of the obtained feature value (S203). For example, the sensor control unit 104 performs control to stop the sensor whose dispersion, which is the feature value, is estimated to be low. Further, the sensor control unit 104 performs control to extract a pair of sensors whose correlation coefficient is estimated to be large and stops one of the sensors. When the sensor whose dispersion, which is the feature value, is estimated to be high is stopping, the sensor control unit 104 performs control to put this sensor into operation. Further, when the control unit 104 extracts a pair of sensors whose correlation coefficient is estimated to be small, and one of those sensors is stopping, the sensor control unit 104 performs control to put this stopping sensor into operation.

In the communication terminal 200, the control unit 211 performs control to stop or restart the sensor according to the control from the power saving model server 100 (S204).

Then, the sensor value interpolation unit 214 performs interpolation of the stopping sensor or stops the interpolation. The control unit 211 receives a designation of a sensor to be stopped and information about a reason for the stop from the power saving model server 100, and the sensor value interpolation unit 214 performs interpolation according to the reason for the stop (dispersion is large/small, or a correlation is large/small).

By performing the above process every specified time period (five minutes in the above example), efficient control of each sensor in the communication terminal 200 is achieved.

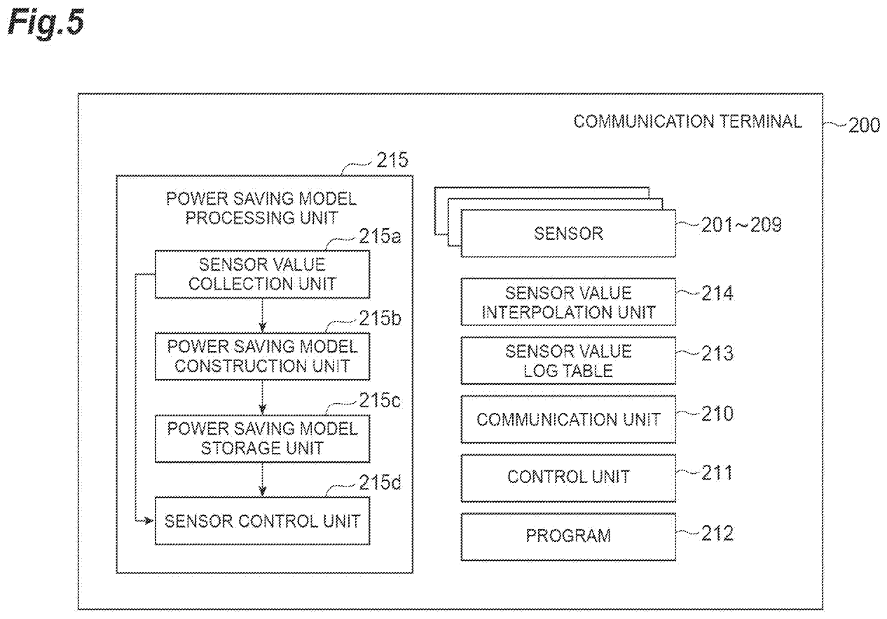

An alternative example where the functions of the power saving model server 100 are included in the communication terminal 200 is described hereinafter. FIG. 5 is a block diagram showing a functional configuration of a communication terminal 200a according to the alternative example. As shown in FIG. 5, the communication terminal 200a includes a power saving model processing unit 215 in addition to the sensors 201 to 209, the communication unit 210, the control unit 211, the program 212, the sensor value log table 213, and the sensor value interpolation unit 214.

This allows the communication terminal 200 to construct a power saving model and estimate a sensor value by use of the power saving model.

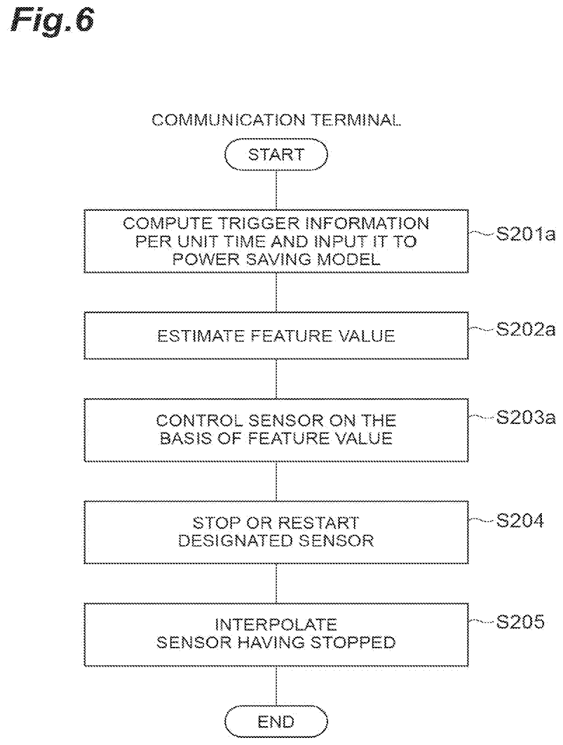

FIG. 6 is a flowchart showing sensor control and interpolation control using the power saving model of the communication terminal 200a.

A sensor control unit 215d computes trigger information on the basis of the WiFi log and the user's behavior information per unit time collected by a sensor value collection unit 215a. For example, the sensor control unit 215d computes the trigger information by referring, every five minutes, to the WiFi log and the user's behavior information in the last 15 minutes. Then, the sensor control unit 215d inputs the trigger information to the power saving model (S201a).

The sensor control unit 215d estimates a feature value from the power saving model (S202a). Then, the sensor control unit 215d controls the operation of each sensor on the basis of the obtained feature value (S203a). The control unit 211 performs control to stop or restart the sensor according to this control (S204).

Then, the sensor value interpolation unit 214 performs interpolation of the stopping sensor or stops the interpolation. The control unit 211 receives a designation of a sensor to be stopped and information about a reason for the stop from the power saving model server 100, and the sensor value interpolation unit 214 performs interpolation according to the reason for the stop (dispersion is large/small, or a correlation is large/small).

By performing the above process every specified time period (five minutes in the above example), efficient control of each sensor in the communication terminal 200 is achieved.

The operational advantages of the power saving model server 100 and the communication terminal 200 according to this embodiment are described hereinafter.

The power saving model server 100 according to this embodiment is an information processing device that controls a plurality of sensors (the acceleration sensor 201 etc.) for detecting a plurality of terminal states. This power saving model server 100 includes the sensor control unit 104 that stops the operation related to one or a plurality of sensors among the plurality of sensors on the basis of the plurality of terminal states.

The terminal state is information on the basis of a sensor value detected by a sensor. The sensor value is acceleration information or the like detected by the acceleration sensor 201 or the like.

Stopping the operation related to one or a plurality of sensors includes stopping the sensor operation and also includes stopping the acquisition of a sensor value acquired by the sensor operation.

In this configuration, the power saving model server 100 is able to stop the operation of a certain sensor among the sensors of the communication terminal 200, which reduces the power consumption by the sensor operation. Further, since the sensor operation is stopped according to the terminal state, a loss of an important sensor value is prevented.

Further, in the power saving model server 100, the sensor control unit 104 stops the operation related to the sensor (the acceleration sensor 201 etc.) that detects the terminal state with small variations among the plurality of terminal states obtained by detection of the plurality of sensors in the communication terminal 200. Specifically, the sensor control unit 104 specifies the sensor where a sensor value with small dispersion is detected, and stops the operation of this sensor.

Since this allows a sensor whose sensor value varies only slightly to be interpolated even when the sensor is not operating, reduction of power consumption and prevention a loss of an important sensor value are achieved.

Particularly, small dispersion means that the sensor value keeps taking a similar value. Thus, even when one given value is taken as a representative value and data is interpolated by copying this value, for example, errors from the original data are small. Interpolating data by stopping the sensor to reduce power consumption when dispersion is small has the technical effect of being able to interpolate data, maintaining the properties of the original data.

Further, in the power saving model server 100, the sensor control unit 104 derives a combination of sensors whose detection results have high similarity among detection results of a plurality of sensors, and stops the operation related to any one of a plurality of sensors in this combination.

Since this allows a sensor whose sensor value varies in proportion to another sensor to be interpolated even when the sensor is not operating, reduction of power consumption and prevention a loss of an important sensor value are achieved.

For example, the fact that values A and B have high similarity (have a correlation or have a high correlation coefficient) indicates that it is likely that when the value A increases/decreases, the value B uniquely increases/decreases. Thus, knowing the relationship between the value A and the value allows estimating the value B from the value A. Since this method observes a change in the value A, the accuracy of interpolation is higher than that in a method of filling a value by the average or the like simply by seeing the value B previous and subsequent to a part to be interpolated. Therefore, reconstructing the sensor data by using the similarity between sensor data enables the data to be reconstructed with higher accuracy compared with a method of reconstructing the sensor data only by using the value before and after interpolation of the sensor.

Further, in the power saving model server 100, when specific one or several sensors among a plurality of sensors obtain a predetermined detection result, the sensor control unit 104 stops the operation related to the plurality of sensors. For example, the specific sensors are sensors that are able to identify a user's behavior, and they are the communication unit that detects a WiFi log, the sensors that detect user's behavior information by Google activity and the like in this embodiment.

Therefore, variations in the terminal state indicated by the sensor value of each sensor and the similarity between the sensors are estimated and determined on the basis of a user's behavior. This efficiently reduces the power consumption on the basis of the sensor operation.

Although the operational advantages are described above by using the power saving model server 100 as an example of the information processing device, the communication terminal 200a according to the alternative example also has the same operational advantages.

Further, the communication terminal 200 and the communication terminal 200a according to this embodiment further include the sensor value interpolation unit 214 that interpolates a detection result of a sensor that has stopped operating by using a detection result of a sensor other than the sensor to be stopped operating.

This prevents a loss of an important sensor value. Therefore, processing using the sensor value, such as estimation of a user's behavior by use of the sensor value, for example, is achieved with high accuracy and low power consumption.

The block diagrams used in the description of the embodiment show blocks in units of functions. These functional blocks (components) are realized in any combination of at least one of hardware and software. Further, a method of realizing each functional block is not particularly limited. That is, each functional block may be realized using one physically or logically coupled device, or may be realized by connecting two or more physically or logically separated devices directly or indirectly (for example, using a wired scheme, a wireless scheme, or the like) and using such a plurality of devices. The functional block may be realized by combining the one device or the plurality of devices with software.

The functions include judging, deciding, determining, calculating, computing, processing, deriving, investigating, searching, confirming, receiving, transmitting, outputting, accessing, resolving, selecting, choosing, establishing, comparing, assuming, expecting, regarding, broadcasting, notifying, communicating, forwarding, configuring, reconfiguring, allocating, mapping, assigning, or the like, but the present invention is not limited thereto. For example, a functional block (a component) that functions for transmission is referred to as a transmitting unit or a transmitter. In any case, a realizing method is not particularly limited, as described above.

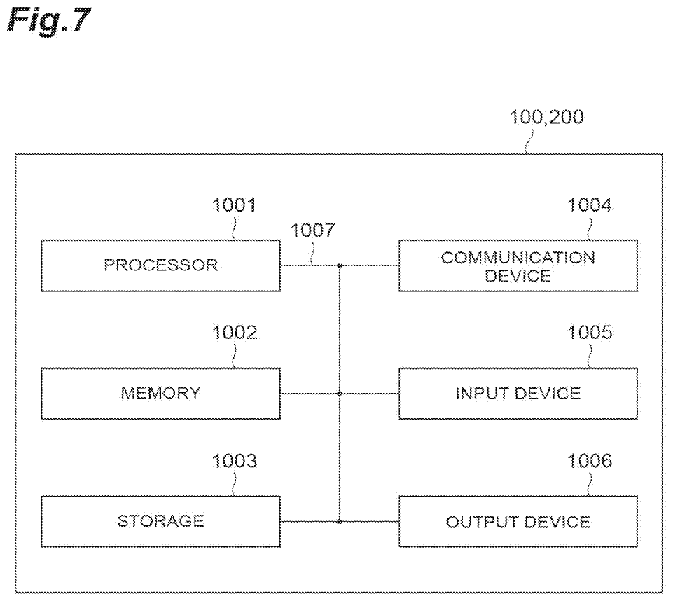

For example, power saving model server 100 and the communication terminal 200 according to the embodiment of the present invention may function as a computer that performs processes of a power saving construction method and a power saving estimation method of the present disclosure. FIG. 7 is a view showing an example of a hardware configuration of the power saving model server 100 and the communication terminal 200 according to the embodiment of the present disclosure. The power saving model server 100 and the communication terminal 200 described above may be physically configured as a computer device including a processor 1001, a memory 1002, a storage 1003, a communication device 1004, an input device 1005, an output device 1006, a bus 1007, and the like.

In the following description, the term “device” can be referred to as a circuit, a device, a unit, or the like. The hardware configuration of the power saving model server 100 and the communication terminal 200 may include one or a plurality of devices illustrated in the figures, or may be configured without including some of the devices.

Each function in the power saving model server 100 and the communication terminal 200 is realized by loading predetermined software (a program) into hardware such as the processor 1001 or the memory 1002 so that the processor 1001 performs computation to control communication that is performed by the communication device 1004 or control at least one of reading and writing of data in the memory 1002 and the storage 1003.

The processor 1001, for example, operates an operating system to control the entire computer. The processor 1001 may be configured as a central processing unit (CPU) including an interface with peripheral devices, a control device, a computation device, a register, and the like. For example, the power saving model construction unit 102 and the sensor control unit 104 in the above power saving model server 100, and the sensor value interpolation unit 214 in the communication terminal 200, and the like described above may be realized by the processor 1001.

Further, the processor 1001 reads a program (program code), a software module, data, or the like from at one of the storage 1003 and the communication device 1004 into the memory 1002 and executes various processes according to the program, the software module, the data, or the like. As the program, a program for causing the computer to execute at least some of the operations described in the above-described embodiment may be used. For example, the power saving model construction unit 102 and the sensor control unit 104 in the power saving model server 100, and the sensor value interpolation unit 214 in the communication terminal 200 may be realized by a control program that is stored in the memory 1002 and operated on the processor 1001, and other functional blocks may be realized similarly. Although the case in which the various processes described above are executed by one processor 1001 has been described, the processes may be executed simultaneously or sequentially by two or more processors 1001. The processor 1001 may be realized using one or more chips. The program may be transmitted from a network via an electric communication line.

The memory 1002 is a computer-readable recording medium and may be configured of, for example, at least one of a read only memory (ROM), an erasable programmable ROM (EPROM), an electrically erasable programmable ROM (EEPROM), and a random access memory (RAM). The memory 1002 may be referred to as a register, a cache, a main memory (a main storage device), or the like. The memory 1002 can store an executable program (program code), software modules, and the like in order to implement the power saving construction method and the power saving estimation method according to the embodiment of the present disclosure.

The storage 1003 is a computer-readable recording medium and may also be configured of, for example, at least one of an optical disc such as a compact disc ROM (CD-ROM), a hard disk drive, a flexible disc, a magneto-optical disc (for example, a compact disc, a digital versatile disc, or a Blu-ray (registered trademark) disc), a smart card, a flash memory (for example, a card, a stick, or a key drive), a floppy (registered trademark) disk, a magnetic strip, and the like. The storage 1003 may be referred to as an auxiliary storage device. The storage medium described above may be, for example, a database including at least one of the memory 1002 and the storage 1003, a server, or another appropriate medium.

The communication device 1004 is hardware (a transmission and reception device) for performing communication between computers via at least one of a wired network and a wireless network and is also referred to as a network device, a network controller, a network card, or a communication module, for example. The communication device 1004 may include a high-frequency switch, a duplexer, a filter, a frequency synthesizer, and the like, for example, in order to realize at least one of frequency division duplex (FDD) and time division duplex (TDD). For example, the sensor value collection unit 101 and the like described above may be realized by the communication device 1004. The sensor value collection unit 101 may be implemented in such a way that a transmitting unit and a receiving unit are physically or logically separated.

The input device 1005 is an input device (for example, a keyboard, a mouse, a microphone, a switch, a button, or a sensor) that receives an input from the outside. The output device 1006 is an output device (for example, a display, a speaker, or an LED lamp) that performs output to the outside. The input device 1005 and the output device 1006 may have an integrated configuration (for example, a touch panel).

Further, the respective devices such as the processor 1001 and the memory 1002 are connected by the bus 1007 for information communication. The bus 1007 may be configured using a single bus or may be configured using buses different for each device.

Further, the power saving model server 100 and the communication terminal 200 may include hardware such as a microprocessor, a digital signal processor (DSP), an application specific integrated circuit (ASIC), a programmable logic device (PLD), or a field programmable gate array (FPGA), and some or all of the functional blocks may be realized by the hardware. For example, the processor 1001 may be implemented by at least one of these pieces of hardware.

Notification of information is not limited to the aspect and embodiment described in the present disclosure and may be made by another method. For example, notification of information may be made by physical layer signaling (for example, downlink control information (DCI) or uplink control information (UCI)), upper layer signaling (for example, radio resource control (RRC) signaling, medium access control (MAC) signaling, or annunciation information (master information block (MIB) or system information block (SIB))), another signal, or a combination of them. Further, RRC signaling may be called an RRC message, and may be, for example, an RRC connection setup message or an RRC connection reconfiguration message.

Further, each aspect/embodiment described in the present disclosure may be applied to at least one of Long Term Evolution (LTE), LTE Advanced (LTE-A), SUPER 3G, IMT-Advanced, 4th generation mobile communication system (4G), 5th generation mobile communication system (5G), Future Radio Access (FRA), new Radio (NR), W-CDMA (registered trademark), GSM (registered trademark), CDMA2000, Ultra Mobile Broadband (UMB), IEEE 802.11 (Wi-Fi (registered trademark)), IEEE 802.16 (WiMAX (registered trademark)), IEEE 802.20, UWB (Ultra Wide Band), Bluetooth (registered trademark), a system using another appropriate system, and a next generation system extended on the basis of such a system. Further, a plurality of systems may be combined (for example, a combination of at least one of LTE and LTE-A, and 5G) and applied.

A process procedure, a sequence, a flowchart, and the like in each aspect/embodiment described in the present disclosure may be in a different order unless inconsistency arises. For example, for the method described in the present disclosure, elements of various steps are presented in an exemplified order, and the elements are not limited to the presented specific order.

Information or the like can be output from an upper layer (or a lower layer) to the lower layer (or the upper layer). The information or the like may be input and output through a plurality of network nodes.

Input or output information or the like may be stored in a specific place (for example, a memory) or may be managed in a management table. Information or the like to be input or output can be overwritten, updated, or additionally written. Output information or the like may be deleted. Input information or the like may be transmitted to another device.

A determination may be performed using a value (0 or 1) represented by one bit, may be performed using a Boolean value (true or false), or may be performed through a numerical value comparison (for example, comparison with a predetermined value).

Each aspect/embodiment described in the present disclosure may be used alone, may be used in combination, or may be used by being switched according to the execution. Further, a notification of predetermined information (for example, a notification of “being X”) is not limited to be made explicitly, and may be made implicitly (for example, a notification of the predetermined information is not made).

Although the present disclosure has been described above in detail, it is obvious to those skilled in the art that the present disclosure is not limited to the embodiments described in the present disclosure. The present disclosure can be implemented as modified and changed aspects without departing from the spirit and scope of the present disclosure defined by the description of the claims. Therefore, the description of the present disclosure is intended for exemplification, and does not have any restrictive meaning with respect to the present disclosure.

Software should be construed widely so that the software means an instruction, an instruction set, a code, a code segment, a program code, a program, a sub-program, a software module, an application, a software application, a software package, a routine, a sub-routine, an object, an executable file, a thread of execution, a procedure, a function, and the like regardless whether the software is called software, firmware, middleware, microcode, or hardware description language or called other names.

Further, software, instructions, information, and the like may be transmitted and received via a transmission medium. For example, when software is transmitted from a website, a server, or another remote source using wired technology (a coaxial cable, an optical fiber cable, a twisted pair, a digital subscriber line (DSL), or the like) and wireless technology (infrared rays, microwaves, or the like), at least one of the wired technology and the wireless technology is included in a definition of the transmission medium.

The information, signals, and the like described in the present disclosure may be represented using any of various different technologies. For example, data, an instruction, a command, information, a signal, a bit, a symbol, a chip, and the like that can be referred to throughout the above description may be represented by a voltage, a current, an electromagnetic wave, a magnetic field or a magnetic particle, an optical field or a photon, or an arbitrary combination of them.

Terms described in the present disclosure and terms necessary for understanding of the present disclosure may be replaced with terms having the same or similar meanings. For example, at least one of a channel and a symbol may be a signal (signaling). Further, a signal may be a message. Further, a component carrier (CC) may be referred to as a carrier frequency, a cell, a frequency carrier, or the like.

The terms “system” and “network” used in the present disclosure are used interchangeably.

Further, the information, parameters, and the like described in the present disclosure may be expressed using an absolute value, may be expressed using a relative value from a predetermined value, or may be expressed using another corresponding information. Names used for the above-described parameters are not limiting names in any way. Further, equations or the like using these parameters may be different from those explicitly disclosed in the present disclosure.

In the present disclosure, the terms such as “Mobile Station (MS)” “user terminal”, “User Equipment (UE)” and “terminal” can be used interchangeably.

The mobile station can be also called, by those skilled in the art, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client or several other appropriate terms.

The term “determining” used in the present disclosure may include a variety of operations. The “determining” can include, for example, regarding judging, calculating, computing, processing, deriving, investigating, search (looking up, search, or inquiry) (for example, search in a table, a database, or another data structure), or ascertaining as “determining.” Further, “determining” can include regarding receiving (for example, receiving information), transmitting (for example, transmitting information), inputting, outputting, or accessing (for example, accessing data in a memory) as “determining.” Further, “determining” can include regarding resolving, selecting, choosing, establishing, comparing or the like as “determining.” That is, “determining” can include regarding a certain operation as “determining.” Further, “determining” may be read as “assuming”, “expecting”, “considering”, or the like.

The terms “connected”, “coupled”, or any modification thereof means any direct or indirect connection or coupling between two or more elements, and can include the presence of one or more intermediate elements between two elements “connected” or “coupled” to each other. The coupling or connection between elements may be physical, may be logical, or may be a combination thereof. For example, “connection” may be read as “access.” When used in the present disclosure, two elements can be considered to be “connected” or “coupled” to each other by using one or more wires, cables, and/or printed electrical connections, or by using electromagnetic energy such as electromagnetic energy having wavelengths in a radio frequency region, a microwave region, and a light (both visible and invisible) region as some non-limiting and non-comprehensive examples.

The description “based on” used in the present disclosure does not mean “based only on” unless otherwise noted. In other words, the description “based on” means both of “based only on” and “based at least on.”

Furthermore, “means” in the configuration of each device described above may be replaced by “unit”, “circuit”, “device” or the like.

When “include”, “including” and modification of them are used in the present disclosure, these terms are intended to be comprehensive like the term “comprising.” Further, the term “or” used in the present disclosure is intended not to be exclusive OR.

In the present disclosure, for example, when articles such as a, an, and the in English are added by translation, the present disclosure may include that nouns following these articles are plural.

In the present disclosure, a sentence “A and B differ” may mean that “A and B are different from each other.” The sentence may mean that “each of A and B is different from C.” Terms such as “separate”, “coupled”, and the like may also be interpreted, similar to “different.”

### REFERENCE SIGNS LIST

100 . . . power saving model server, 101 . . . sensor value collection unit, 102 . . . power saving model construction unit, 103 . . . power saving model storage unit, 104 . . . sensor control unit, 200 . . . communication terminal, 200a . . . communication terminal, 201 . . . acceleration sensor, 202 . . . angular velocity sensor, 203 . . . tilt sensor, 204 . . . atmospheric pressure sensor, 205 . . . illumination sensor, 207 . . . sensor, 208 . . . application use sensor, 209 . . . battery sensor, 210 . . . communication unit, 211 . . . control unit, 212 . . . program, 213 . . . sensor value log table, 214 . . . sensor value interpolation unit, 215 . . . power saving model processing unit, 215a . . . sensor value collection unit, 215d . . . sensor control unit

1. An information processing device for controlling a plurality of detection units that respectively detect a plurality of terminal states, comprising:
a sensor control unit configured to stop an operation related to one or a plurality of detection units among the plurality of detection units on the basis of the plurality of terminal states.

2. The information processing device according to claim 1, wherein
the sensor control unit stops an operation related to a detection unit that detects a terminal state with small variations among the plurality of terminal states respectively obtained by detection of the plurality of detection units.

3. The information processing device according to claim 1, wherein
the sensor control unit derives a combination of detection units whose detection results have high similarity among detection results of the plurality of detection units, and stops an operation related to any one of the plurality of detection units in the combination.

4. The information processing device according to claim 1, wherein
the sensor control unit stops an operation related to the plurality of detection units when specific one or several detection units among the plurality of detection units obtain a predetermined detection result.

5. The information processing device according to claim 4, wherein
the specific one or several detection units are detection units able to identify a user's behavior.

6. The information processing device according to claim 1, further comprising:
a detection result interpolation unit configured to interpolate a detection result of a detection unit having stopped operating by using a detection result of a detection unit other than the detection unit to be stopped operating.

7. The information processing device according to claim 2, wherein
the sensor control unit derives a combination of detection units whose detection results have high similarity among detection results of the plurality of detection units, and stops an operation related to any one of the plurality of detection units in the combination.
